(19) United States
(12) Patent Application Publication
(10) Pub. No.: US 2014/0169243 A1
(43) Pub. Date: Jun. 19, 2014

(54) MOBILE COMMUNICATION CIRCUITRY FOR THREE OR MORE ANTENNAS

(71) Applicant: RF MICRO DEVICES, INC., Greensboro, NC (US)

(72) Inventors: Nadim Khlat, Cugnaux (FR); Marcus Granger-Jones, Scotts Valley, CA (US)

(73) Assignee: RF MICRO DEVICES, INC., Greensboro, NC (US)

(21) Appl. No.: 14/133,024

(22) Filed: Dec. 18, 2013

Related U.S. Application Data
(60) Provisional application No. 61/738,560, filed on Dec. 18, 2012.

(51) Int. Cl. H04L 5/08

(52) U.S. Cl. CPC H04L 5/08
USPC 370/297

(57) ABSTRACT

Communication circuitry is disclosed that is capable of switching between three or more antennas while providing low harmonic interference during carrier aggregation. In one embodiment, a communication system includes a first switch with two poles and four throws, a second switch with two poles and four throws, and four diplexers associated with four antennas. In a second embodiment, the communication system includes a first switch with three poles and three throws, a second switch with three poles and three throws, and three diplexers associated with three antennas. In the second embodiment, the second switch may have a third pole associated with non-cellular signals such as GPS and WiFi, and one or more of the diplexers may be tunable, for example to efficiently pass 1.575 GHz for GPS signals.

### RELATED APPLICATIONS

This application claims the benefit of provisional patent application Ser. No. 61/738,560, filed Dec. 18, 2012, the disclosure of which is hereby incorporated herein by reference in its entirety.

### FIELD OF THE DISCLOSURE

The present disclosure relates to circuitry for use in a mobile device. Specifically, the present disclosure relates to circuitry for use in a mobile device with three or more antennas and carrier aggregation.

### BACKGROUND

Modern mobile telecommunications standards continue to demand increasingly greater rates of data exchange (data rates). One way to achieve a high data rate in a mobile device is through the use of carrier aggregation. Carrier aggregation allows a single mobile device to aggregate bandwidth across one or more operating bands in the wireless spectrum. The increased bandwidth achieved as a result of carrier aggregation allows a mobile device to obtain higher data rates than have previously been available.

FIG. 1 shows a table describing a number of wireless communications bands in the wireless spectrum. One or more of the wireless communications bands may be used, for example, in a CDMA (Code Division Multiple Access), GSM (Global System for Mobile communications), LTE (Long Term Evolution), or LTE-advanced equipped mobile device. The first column indicates the operating band number for each one of the operating bands. The second and third columns indicate the uplink and downlink frequency bands for each one of the operating bands, respectively. Finally, the fourth column indicates the duplex mode for each one of the operating bands. In non-carrier aggregation configurations, a mobile device will generally communicate using a single portion of the uplink or downlink frequency bands within a single operating band. In carrier aggregation applications, however, a mobile device may aggregate bandwidth across a single operating band or multiple operating bands in order to increase the data rate of the device.

FIG. 2A shows a diagram representing a conventional, non-carrier aggregation configuration for a mobile device. In this conventional configuration, a mobile device communicates using a single portion of the wireless spectrum 10 within a single operating band 12. Under the conventional approach, the data rate of the mobile device is constrained by the limited available bandwidth.

FIGS. 2B-2D show diagrams representing a variety of carrier aggregation configurations for a mobile device. FIG. 2B shows an example of contiguous, intra-band carrier aggregation, in which the aggregated portions of the wireless spectrum 14A and 14B are located directly adjacent to one another and are in the same operating band 16. FIG. 2C shows an example of non-contiguous intra-band carrier aggregation, in which the aggregated portions of the wireless spectrum 18A and 18B are located within the same operating band 20, but are not directly adjacent to one another. Finally, FIG. 2D shows an example of inter-band carrier aggregation, in which the aggregated portions of the wireless spectrum 22A and 22B are located in different operating bands 24 and 26. A modern mobile device should be capable of supporting each one of the previously described carrier aggregation configurations.

The use of carrier aggregation may pose unique problems for the front end circuitry in a mobile device. For instance, a mobile device using carrier aggregation may require multiple antennas. The use of more than one antenna may complicate the design of the front-end switching circuitry within the mobile device. Additionally, the use of carrier aggregation across certain operating bands may cause undesirable interference between transmit and receive circuitry in a mobile device front end that renders the mobile device unusable in these operating bands.

FIG. 3 shows conventional front end circuitry 28 for use in a mobile terminal for a single feed antenna supporting inter-band carrier aggregation between low band and mid/high band bands. The conventional front end circuitry 28 includes antenna switching circuitry 30, a diplexer 32, and an antenna 34. The antenna switching circuitry 30 includes low band switching circuitry 36 and high band switching circuitry 38. The low band switching circuitry 36 is adapted to couple one of a first plurality of RF front end ports 40 to the antenna 34 through the diplexer 32. The high band switching circuitry 38 is adapted to couple one of a second plurality of RF front end ports 42 to the antenna 34 through the diplexer 32. The diplexer 32 includes a low band port 44 coupled to the low band switching circuitry 36, a high band port 46 coupled to the high band switching circuitry 38, and an antenna port 48 coupled to the antenna 34. The diplexer 32 is adapted to pass high band signals falling within a high pass band between the high band port 46 and the antenna port 48, pass low band signals falling within a low pass band between the low band port 44 and the antenna port 48, and attenuate signals outside of the high and low pass bands. Although effective at selectively placing the antenna 34 in communication with the appropriate RF front end port, the conventional front end circuitry 28 shown in FIG. 3 is not suitable for carrier aggregation applications that require multiple antennas. Specifically, the FIG. 3 circuitry is not suitable for antenna swapping. For diversity systems, circuitry may simply replicate this subsystem for the diversity path. However, for antenna swapping the circuitry needs switches that allow antenna swapping.

FIG. 4 shows conventional front end circuitry 50 for use in a mobile terminal that supports antenna swapping with two antennas. The conventional front end circuitry 50 includes antenna switching circuitry 52, a first diplexer 54A, a second diplexer 54B, a first antenna 56A, and a second antenna 56B. The antenna switching circuitry 52 includes first antenna switching circuitry 52A and second antenna switching circuitry 52B. The first antenna switching circuitry 52A includes first low band switching circuitry 58, first high band switching circuitry 60, second low band switching circuitry 62, and second high band switching circuitry 64. The first low band switching circuitry 58 and the first high band switching circuitry 60 are adapted to selectively couple one of a first plurality of RF front end ports 66 to the second antenna switching circuitry 52B through the first diplexer 54A. The second low band switching circuitry 62 and the second high band switching circuitry 64 are adapted to selectively couple one of a second plurality of RF front end ports 68 to the second antenna switching circuitry 52B through the second diplexer 54B. The second antenna switching circuitry 52B includes antenna selection circuitry 70, which is adapted to selectively place the first antenna 56A and the second antenna 56B in communication with either the first diplexer 54A or the second diplexer 54B.

The antenna switching circuitry 52 may comprise a plurality of transistors and other assorted passive components. As is well known in the art, non-linearity of the transistors and other passive components within the antenna switching circuitry 52 may generate harmonic distortion around a passing signal. In certain carrier aggregation configurations, the generated harmonic distortion can cause desensitization of receive circuitry in the conventional front end circuitry 50 illustrated in FIG. 4. For example, the conventional front end circuitry 50 may experience problems in a carrier aggregation configuration using bands 3 and 8 (CA 3-8). In a CA 3-8 configuration, the conventional front end circuitry 50 will couple one of the second plurality of RF front end ports 68 corresponding with the band 8 transmit port to the antenna selection circuitry 70 in order to transmit a carrier signal between 880-915 MHz. As the carrier signal passes through the first low band switching circuitry 58, harmonic distortion is generated. The carrier signal and harmonic distortion travel through the first diplexer 54A, where the harmonic distortion is effectively filtered. However, as the carrier signal travels through the antenna selection circuitry 70, additional harmonic distortion is generated.

Because at least a portion of the second harmonic of the band 8 uplink band (1760-1830 MHz) falls within the band 3 downlink band (1805-1880 MHz), components of the harmonic distortion around the second harmonic are within the high pass band of the first diplexer 54A, and a portion of the harmonic distortion will be delivered to the first high band switching circuitry 60. Further, because the conventional front end circuitry 50 is configured to simultaneously transmit on band 8 and receive on band 3, one of the first plurality of RF front end ports 66 corresponding with the band 3 receive port will be coupled to the first diplexer 54A through the first high band switching circuitry 60. Accordingly, a portion of the distorted band 8 transmit signal about the second harmonic will be delivered to the band 3 receive circuitry, where it will cause desensitization. Additionally, the harmonic distortion in the carrier signal will be presented to the antennas 56A and 56B, thereby degrading the quality of the wireless signal. As a result of the desensitization of the receiver circuitry, the performance of the conventional front end circuitry 50 illustrated in FIG. 4 may suffer in a CA 3-8 configuration.

As an additional example, the conventional front end circuitry 50 will also experience problems in carrier-aggregation applications using bands 4 and 17 (CA 4-17), because the third harmonic of a band 17 transmit signal (2112-2148 MHz) falls within a band 4 receive signal (2110-2155 MHz). The problem with the conventional front end circuitry 50 may occur in any carrier aggregation configuration using operating bands in which the harmonic components of the carrier signal fall within the frequency band of the receive signal. The limited combination of operating bands usable in a carrier aggregation configuration by the conventional front end circuitry 50 illustrated in FIG. 4 may impede the performance and versatility of a mobile device. Accordingly, front end switching circuitry for a mobile device with two or more antennas is needed that is suitable for carrier aggregation applications across all bands.

FIG. 5 shows a conventional diplexer 72 for use in the conventional front end circuitry 28 and 50 shown in FIGS. 3 and 4. The conventional diplexer 72 is based on a fourth order Butterworth response, and includes an antenna port 74, a low band port 76, a high band port 78, a high pass filter 80, and a low pass filter 82. The high pass filter 80 includes a first high band inductor L1_HB coupled between the high band port 78 and ground, a first high band capacitor C1_HB coupled between the high band port 78 and a first high band node 81, a second high band inductor L2_HB coupled between the first high band node 81 and ground, and a second high band capacitor C2_HB coupled between the first high band node 81 and the antenna port 74. The low pass filter 82 includes a first low band capacitor C1_LB coupled between the low band port 76 and ground, a first low band inductor L1_LB coupled between the low band port 76 and a first low band node 83, a second low band capacitor C2_LB coupled between the first low band node 83 and ground, and a second low band inductor L2_LB coupled between the first low band node 83 and the antenna port 74. The conventional diplexer 72 is designed to pass high band signals falling within a high pass band between the antenna port 74 and the high band port 78, pass low band signals falling within a low pass band between the antenna port 74 and the low band port 76, and attenuate signals outside of the high and low pass bands.

The conventional diplexer 72 allows a mobile terminal to transmit and receive a high band signal and a low band signal simultaneously, thereby increasing the data rate of the mobile device. Although effective at separating low and high band signals, the conventional diplexer 72 is limited to fixed pass bands for the low and high band signals. In certain carrier aggregation applications, the rigidity of the conventional diplexer 72 may degrade the performance of a mobile device into which it is incorporated. Carrier aggregation applications may demand more precise control over the high and low pass bands, greater stop band attenuation, and lower insertion loss. To achieve the desired pass and stop bands, a seventh or eighth order Butterworth response may be required according to the conventional design. Such a high order filter would be complex to implement, and would further introduce a high amount of insertion loss into the signal path to the antenna.

There are problems and limitations with conventional mobile communication devices circuitry using two antennas, wherein a first antenna (or main antenna) is configured for transmitting or receiving the main signal, and a second antenna (or diversity antenna) is dedicated to receiving a diversity signal.

Some techniques may improve performance with two antennas. The two antennas may be swapped (“antenna swapping”) so that the most efficient antenna is used for transmission; in other words, so that the main transmission is transmitted over the most efficient antenna (e.g., the antenna NOT covered by a user's hand). Also in the case of two antennas, diplexers may be used near an antenna so that a low band signal and a high band signal are received simultaneously by a single antenna, and then diplexed into separate signals for separate processing. However, using only two antennas imposes inherent limitations on the performance of mobile devices.

There is a need for communication circuitry that is capable of switching between three or more antennas while providing low harmonic interference during carrier aggregation.

### SUMMARY

Circuitry is disclosed for switching between three or more antennas while providing low harmonic interference during carrier aggregation.

In one embodiment, a communication system includes a first switch with two poles and four throws, a second switch with two poles and four throws, and four diplexers associated with four antennas. The first switch has a first pole associated with a main low band signal, a second pole associated with a second low band signal, a first throw associated with a first diplexer and a first antenna, a second throw associated with a second diplexer and a second antenna, a third throw associated with a third diplexer and a third antenna, and a fourth throw associated with a fourth diplexer and a fourth antenna.

The second switch has a first pole associated with a main high band signal, a second pole associated with a second high band signal, and four throws similar to the throws of the first switch. The second switch may have a third pole associated with non-cellular signals such as GPS and WiFi. One or more of the diplexers may be tunable, for example to pass 1.575 GHz for GPS signals.

Those skilled in the art will appreciate the scope of the present disclosure and realize additional aspects thereof after reading the following detailed description of the preferred embodiments in association with the accompanying drawing figures.

### BRIEF DESCRIPTION OF THE FIGURES

The accompanying figures incorporated in and forming a part of this specification illustrate several aspects of the disclosure, and together with the description serve to explain the principles of the disclosure.

FIG. 1 is a table showing a number of wireless communications bands within the wireless spectrum.

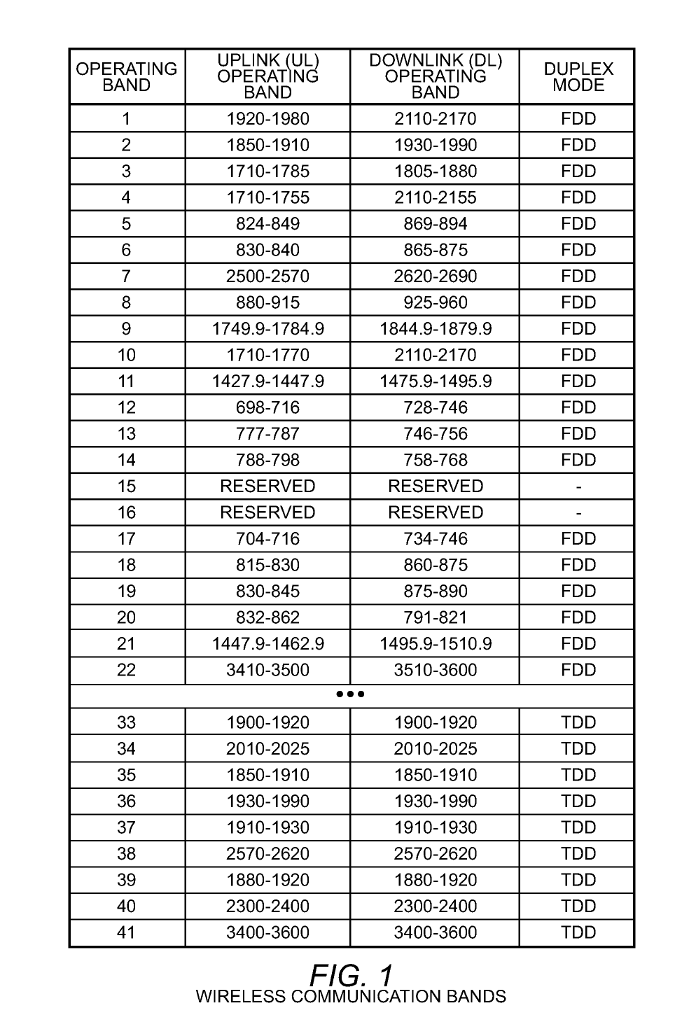

FIGS. 2A-2D are diagrams showing a variety of carrier aggregation configurations for use in a mobile terminal.

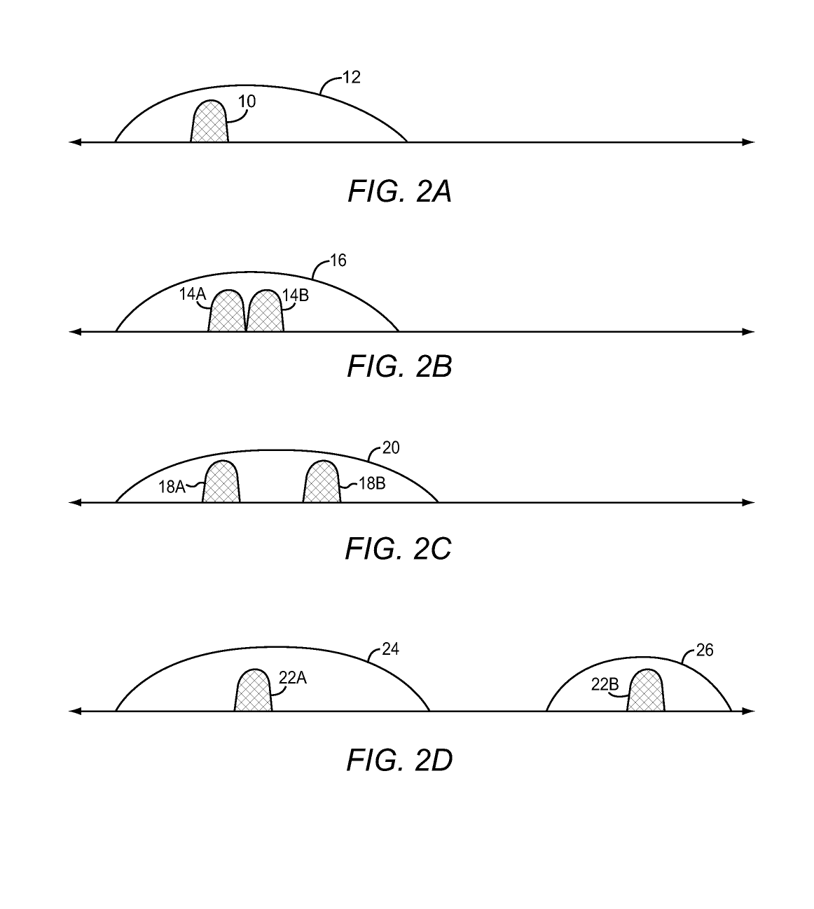

FIG. 3 is a schematic representation of conventional front end switching circuitry.

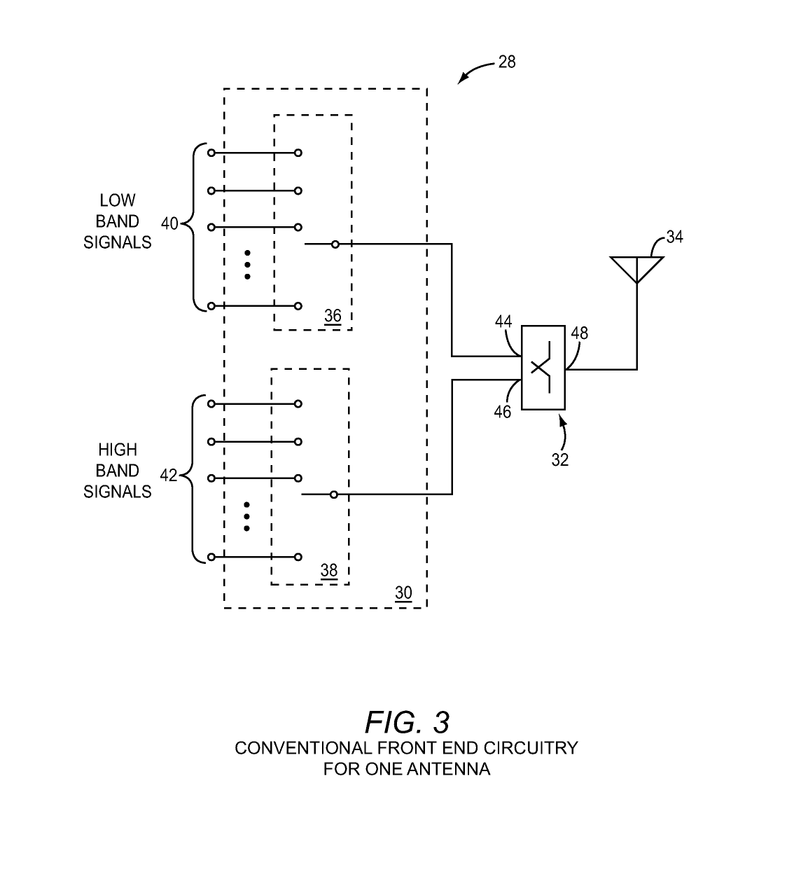

FIG. 4 is a schematic representation of conventional front end switching circuitry for use with two antennas.

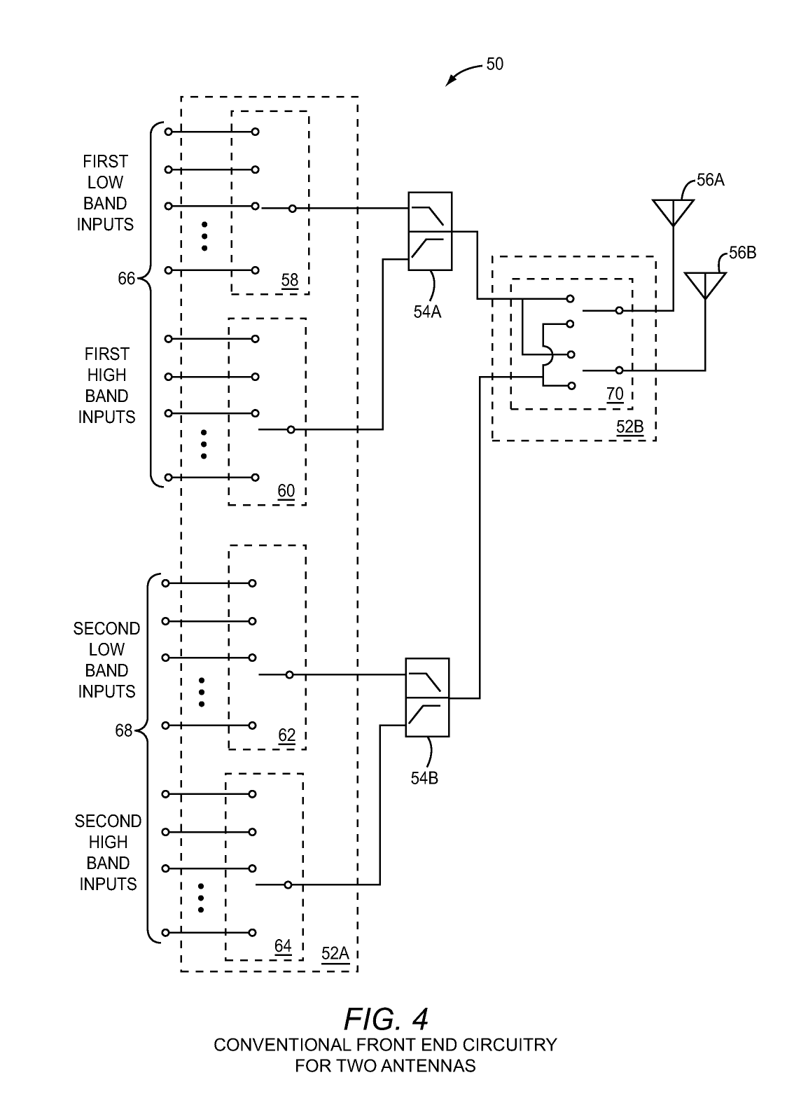

FIG. 5 is a schematic representation of a conventional diplexer.

FIG. 6 is a floor plan of a smart phone with four antennas according to the present disclosure.

FIG. 7 is an embodiment with diplexers after multiplexers, and with four antennas.

FIG. 8 is an embodiment with a multiplexer after the diplexers, and with four antennas.

FIG. 9 is an embodiment with diplexers after multiplexers, with four antennas, with an antenna switch module, and with a diversity switch module.

FIG. 10 is an embodiment with diplexers after multiplexers, and with three antennas.

FIG. 11 is an embodiment with diplexers after multiplexers, with three antennas, and with a GPS input.

FIG. 12 is an embodiment with diplexers after multiplexers, with four antennas, with a GPS input, and with two 3P4T switches.

FIG. 13 is a block diagram of front end circuitry.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts not particularly addressed herein. It should be understood that these concepts and applications fall within the scope of the disclosure and the accompanying claims.

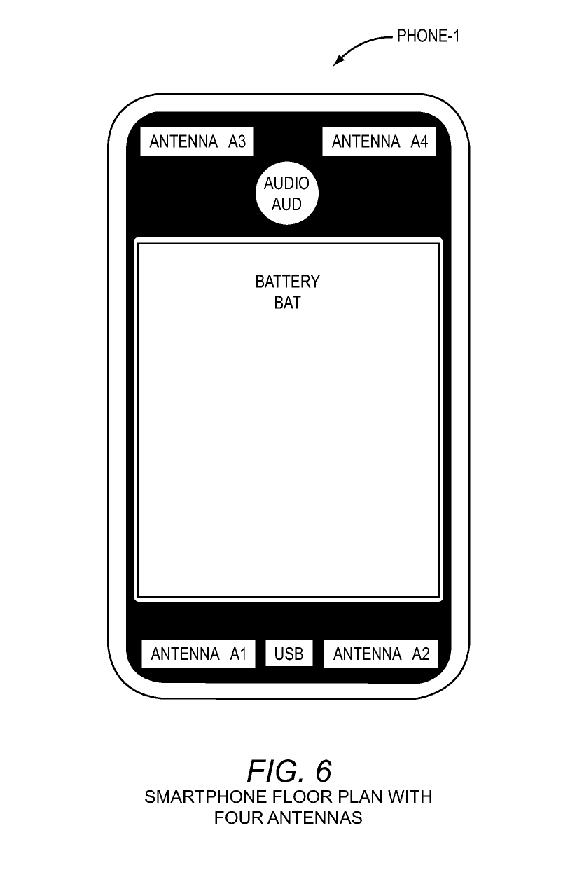

FIG. 6 is a floor plan of a smart phone with four antennas according to the present disclosure. Specifically, smart phone PHONE-1 provides an exemplary layout including: four antennas (A1, A2, A3, and A4) located at the four corners of the phone; a battery BAT consuming the majority of the central space of the phone; an audio portion AUD; and a wire communication port such as a universal serial bus port USB.

In this exemplary layout, the four antennas are located at the four corners in order to maximize the physical distance separating the antennas, and to minimize the probability that a user's hand covers more than two of the antennas. Further, this layout allows the battery to occupy the large central space of the phone. The antennas may be placed in other locations.

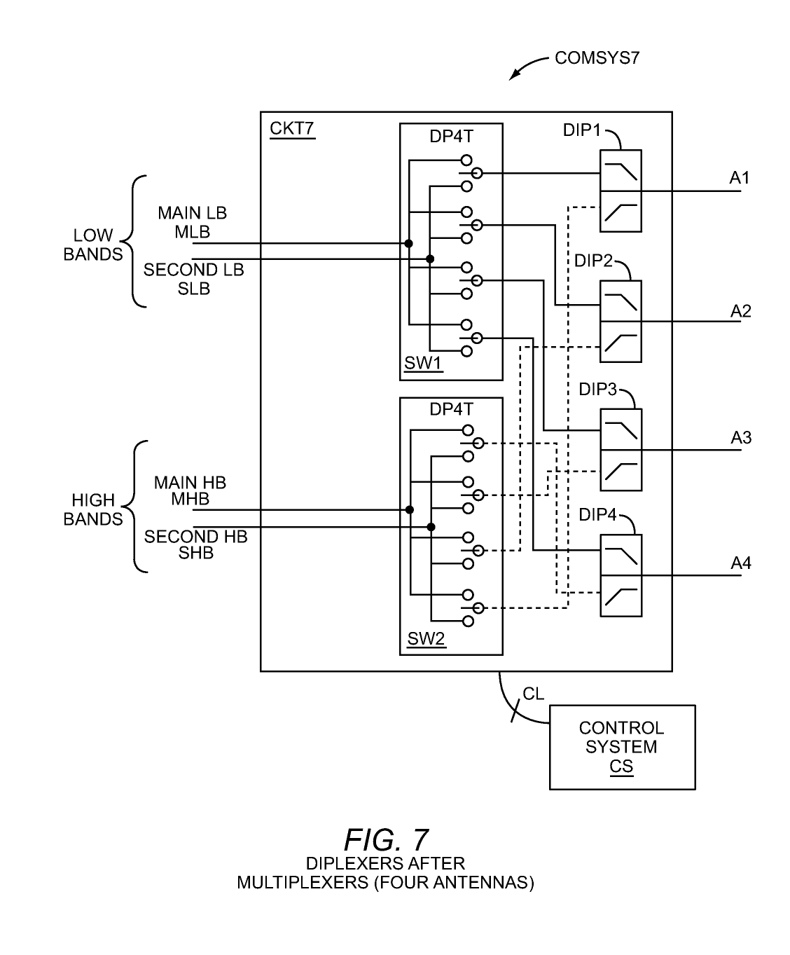

FIG. 7 is an embodiment with diplexers after multiplexers, and with four antennas. Specifically, a communication system comprises communication circuitry CKT7, control system CS, and antennas A1-A4.

Communication circuitry CKT7 includes first switch SW1, second switch SW2, and four diplexers (DIP1, DIP2, DIP3, and DIP4). The four diplexers are connected to four antennas (A1, A2, A3, and A4 respectively). Control system CS is in communication with communication circuitry CKT7 through control lines CL. These two switches (SW1 and SW2) act as a 4×4 multiplexer (four inputs and four outputs).

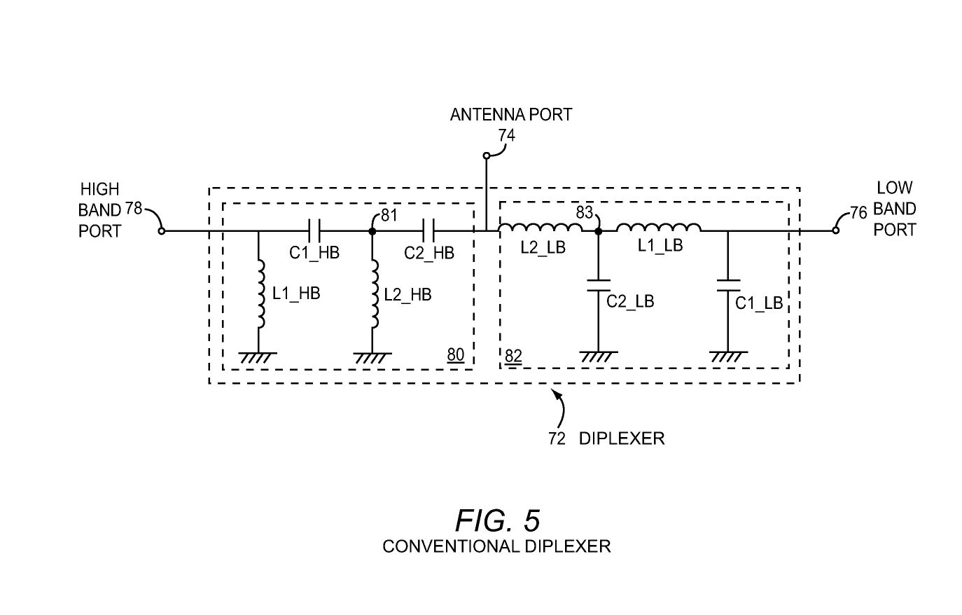

The diplexers may be tunable. As shown in FIG. 7, diplexer DIP1 is configured to pass low frequencies in the upper half (low pass section, connecting to SW1), and to pass high frequencies in the lower half (high pass section, connecting to SW2). A tunable diplexer could be tuned in this fashion, or could be tuned in the reverse fashion. Tunable diplexers may be controlled by control system CS. The term “low pass section” is defined broadly, and includes at least two possibilities: passing all low frequencies below a first cutoff frequency (such as the low band 82 of conventional diplexer 72 in FIG. 5), or passing all low frequencies within a low frequency band (the low frequency band defined as below the first cutoff frequency and above a second cutoff frequency). In this fashion, very, very low frequencies may be blocked by the “low pass section.” In other words, the low pass section may be a low bandpass section that also blocks very, very low frequencies. Similarly, the term “high pass section” is defined broadly, and may block very, very high frequencies.

Further, a diplexer may be tuned as a function of frequency of operation such that the high pass section and the low pass section minimize insertion loss (IL).

Alternatively (or additionally), the diplexer may be tuned such that a stop band zero in the low pass section is tuned as a function of a mode of operation to provide attenuation at problematic frequencies (e.g., the second or third harmonic of low band transmit, or GPS receiving frequency, or 2.4 GHz ISM (Industrial, Scientific, and Medical) frequency).

First switch SW1 is a DP4T (double pole, four throw) switch that receives main low band signal MLB (at a first pole of the first switch) and second low band signal SLB (at a second pole of the first switch), and outputs to four diplexers. This switch may, for example, send MLB to DIP1 (towards antenna A1), and send SLB to DIP3 (towards antenna A3). Antennas A1 and A3 are located at opposite corners of the phone (see FIG. 6), and thus have a maximum physical separation that reduces interference between these antennas. Signals received by the antennas flow in the opposite direction through the circuitry.

Second switch SW2 is similar to SW1, but instead receives main high band MHB and second high band SHB. The second low band and second high band signals may be referred to as MIMO (Multiple Input, Multiple Output) signals, or as diversity signals.

Placing diplexers between the switches and the antennas provides certain advantages. For example, a broadband signal (including a low band signal and a high band signal) may be received by antenna A1, separated by diplexer DIP1, and then the low band signal may be sent to switch SW1 and the high band signal may be sent to switch SW2. This early separation of received signals (by diplexer DIP1) reduces any interference between the signals during switching (in SW1 and SW2). Similar advantages may apply when transmitting a broadband signal (including a low band signal and a high band signal), because the low band signal may be switched by switch SW1 and the high band signal may be switched by SW2 before transmission of both signals by antenna A1.

Communication circuitry CKT7 may include directional couplers (not shown) in each of the signal lines (MLB, SLB, MHB, and SHB) for measuring power. The directional couplers may have associated switching circuitry (not shown) and associated control lines. Various reference voltages and buses (not shown) may be communicating with communication circuitry CKT7.

Control system CS may control communication circuit CKT7 through control lines CL. These control lines may control switches SW1 and SW2, diplexers DIP1-DIP4, and other elements of CKT7 that are not shown.

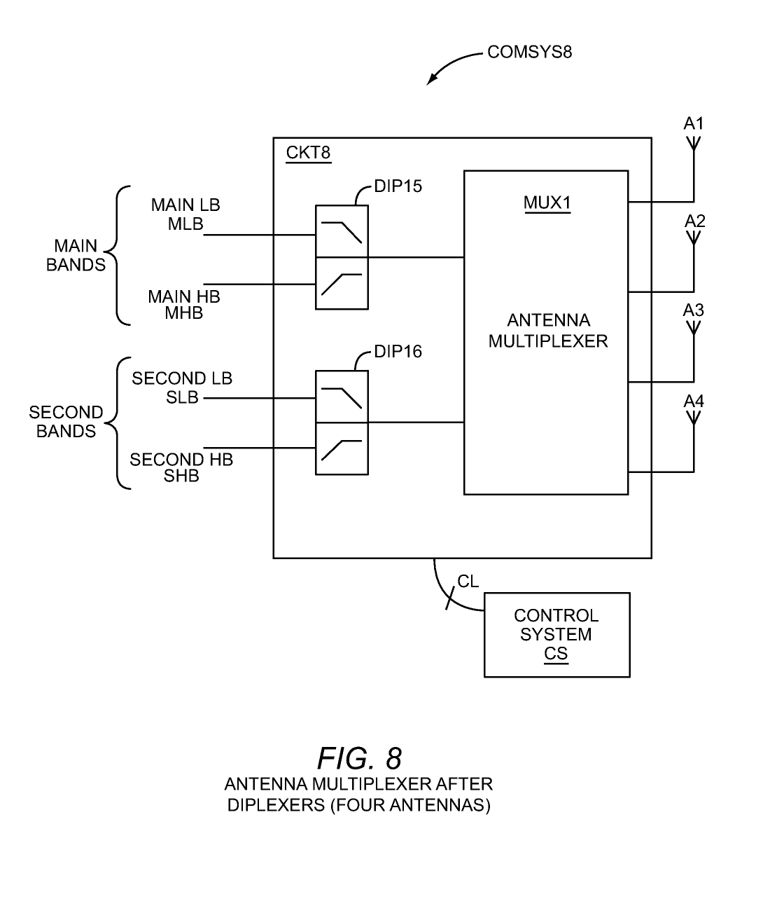

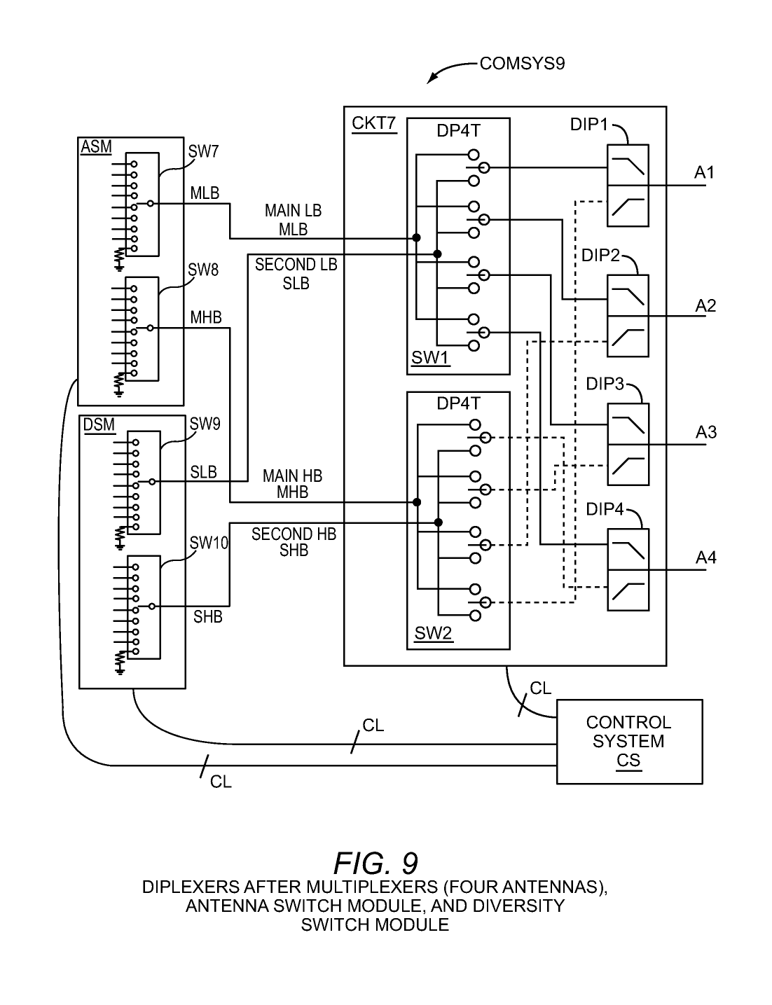

In the configuration of FIG. 7, the number of diplexers equals the number of antennas. Using tunable diplexers in this configuration allows optimized tuning and can replace external diplexers (diplexers not located between the switches and the antennas). A transmit chain includes: power amplifiers (not shown), duplexers (not shown), an antenna switch module (not shown in FIG. 7, but see antenna switch module ASM in FIG. 9)), and the multiplexing switches (SW1 and SW2). Thus, harmonics created by the transmit chain may be filtered by the tunable diplexers just before transmission by an antenna. Other configurations may place the diplexers in other locations, see description of FIG. 8 below.

FIG. 8 is an embodiment with a multiplexer after diplexers, and with four antennas. A communication system COMSYS8 comprises communication circuitry CKT8, control system CS, and antennas A1-A4.

Specifically, communication circuitry CKT8 receives four signals (main low band MLB, main high band MHB, second low band SLB, and second high band SHB), and outputs to four antennas (A1, A2, A3, and A4). Communication circuitry CKT8 includes diplexers DIP15 and DIP16, and antenna multiplexer MUX1. Antenna multiplexer MUX1 may comprise two SP4T (single pole, four throw) switches (not shown). Control system CS is in communication with communication circuit CKT8 through control lines CL.

In comparison with FIG. 7, FIG. 8 has moved the diplexers to the left of the multiplexer (further away from the antennas). This movement reduces the number of diplexers to two (from four), and also simplifies the multiplexer (two SP4T switches instead of two DP4T switches).

FIG. 8 may have problems because harmonics created by the switches will continue to the antennas (without filtering by the FIG. 7 diplexers between the switches and the antennas), and may create unacceptable interference (e.g., when transmitting in band 17, the third harmonic will interfere with receiving in band 4). This FIG. 8 configuration is especially problematic when a single antenna shares a low band signal and a high band signal. Thus, the FIG. 8 configuration has some advantages and some disadvantages compared with the FIG. 7 configuration.

FIG. 9 is an embodiment with diplexers after multiplexers, with four antennas, with an antenna switch module, and with a diversity switch module. Specifically, a communication system COMSYS9 comprises communication circuitry CKT7, antenna switch module ASM, diversity switch module DSM, control system CS, and antennas A1-A4.

FIG. 9 is similar to FIG. 7, retaining communication circuitry CKT7, control system CS, and antennas A1 to A4. FIG. 9 adds an antenna switch module ASM and a diversity switch module DSM. These modules may be contact MEMS (microelectromechanical systems) structures.

The antenna switch module ASM uses switch SW7 to select a specific low band signal as a main low band (MLB) signal, and uses switch SW8 to select a specific high band signal as a main high band (MHB) signal.

The diversity switch module DSM uses switch SW9 to select a specific low band as a second low band SLB signal, and uses switch SW10 to select a specific high band as a second high band SHB signal.

Control system CS may control communication circuit CKT7 through control lines CL, as discussed above in FIG. 7. These control lines CL may also control antenna switch module ASM and diversity switch module DSM, specifically controlling the selection of individual bands by switches SW7-SW10.

In one embodiment (not shown), extra RF ports may be added to the multiplexer. For example, a transmit port and a receive port for LTE-TDD (long-term evolution time-division duplex) may be added.

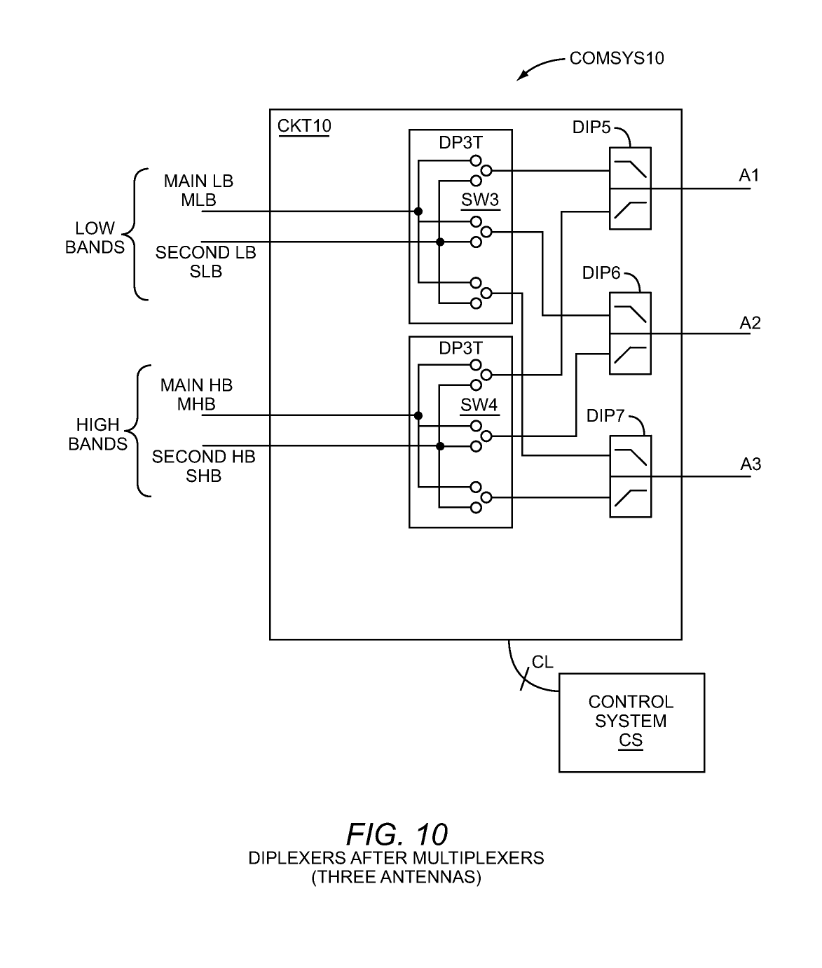

FIG. 10 is an embodiment with diplexers after multiplexers, and with three antennas. Specifically, a communication system COMSYS10 comprises communication circuitry CKT10, control system CS, and antennas A1-A3.

FIG. 10 is similar to FIG. 7, except that only three antennas are provided (instead of four), and the switches are DP3T (double pole, three throw) instead of DP4T (double pole, four throw). This three antenna configuration retains many of the advantages of the four antenna configuration.

Specifically, in FIG. 10, communication circuitry CKT10 includes first switch SW3, second switch SW4, and diplexers DIPS, DIP6, and DIP7. Diplexers DIPS, DIP6, and DIP7 are in communication with antennas A1, A2, and A3 respectively. Control system CS is in communication with communication circuitry CKT10 through control lines CL.

First switch SW3 receives main low band MLB (at a first pole of the first switch) and second low band SLB (at a second pole of the first switch), and outputs to diplexers DIPS, DIP6, and DIP7 (from the first throw, second throw, and third throw of the first switch respectively).

Second switch SW4 receives main high band MHB (at a first pole of the second switch) and second high band SHB (at a second pole of the second switch), and outputs to diplexers DIPS, DIP6, and DIP7 (from the first throw, second throw, and third throw of the second switch respectively).

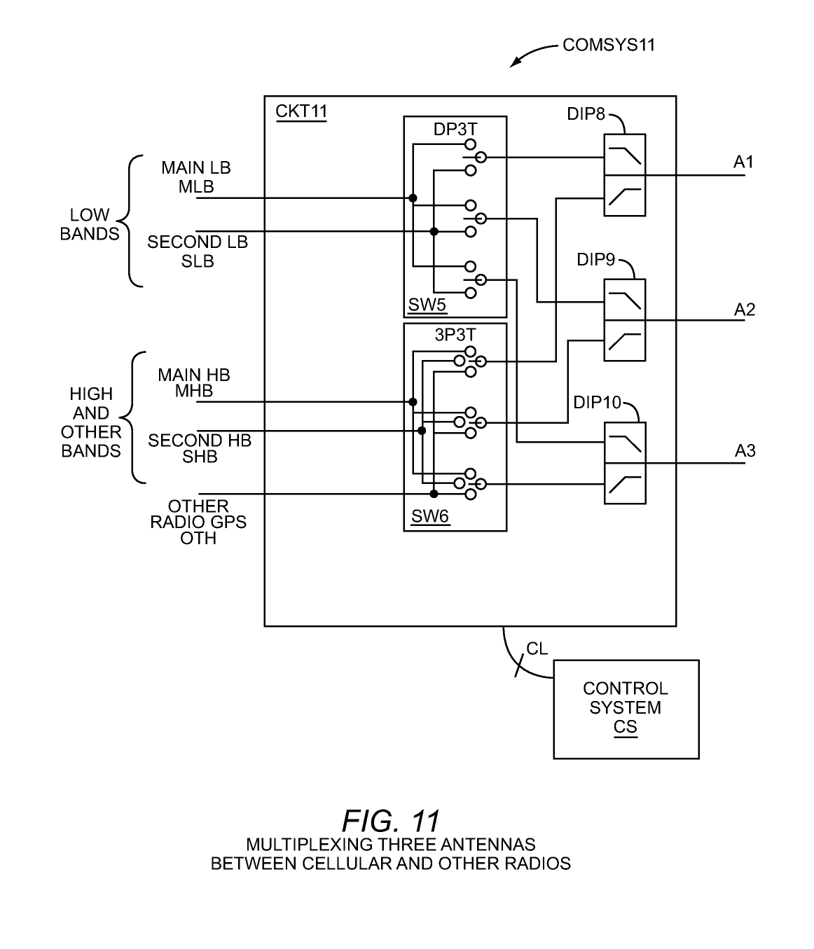

FIG. 11 is a communication system with diplexers after multiplexers, with three antennas, and with a GPS or middle band input. Specifically, a communication system COMSYS11 comprises communication circuitry CKT11, control system CS, and antennas A1-A3.

FIG. 11 is similar to FIG. 10, except that a third input OTH has been added to switch SW6 to provide for “other” (non-cellular) radio signals such as GPS (global positioning satellite, 1.575 GHz), Bluetooth, ISM band (2400-2480 MHz), and WiFi.

Specifically, communication circuitry CKT11 includes first switch SW5, second switch SW6, three diplexers (DIPS, DIP9, and DIP10). The diplexers are associated with three antennas (A1, A2, and A3 respectively). Control system CS controls communication circuitry CKT11 through control lines CL.

For example, the antenna A1 transmits/receives a cellular high band signal, antenna A2 receives a diversity signal, and antenna A3 transmits/receives a WiFi 2.4 GHz signal. The robust circuitry in FIG. 11 permits “antenna swapping” among these three signals, for example swapping A1 with A3.

In another example, during low band cellular operation the communication system may transmit/receive the 2.4 GHz ISM band or may receive the 1.575 GHz GPS signal through any antenna, regardless of which antennas are being used for low band cellular communication.

Further, a high band pass portion of a tunable diplexer may be tuned to 1.575 GHz to pass the received GPS signal. Typically, high band pass portions are designed to pass 1710 MHz and typically have 2 or 3 dB loss at 1.575 GHz. Thus, a tunable diplexer may be tuned for cellular signals or tuned for GPS signals. One diplexer may be tunable, or more than one diplexer may be tunable to provide even greater flexibility.

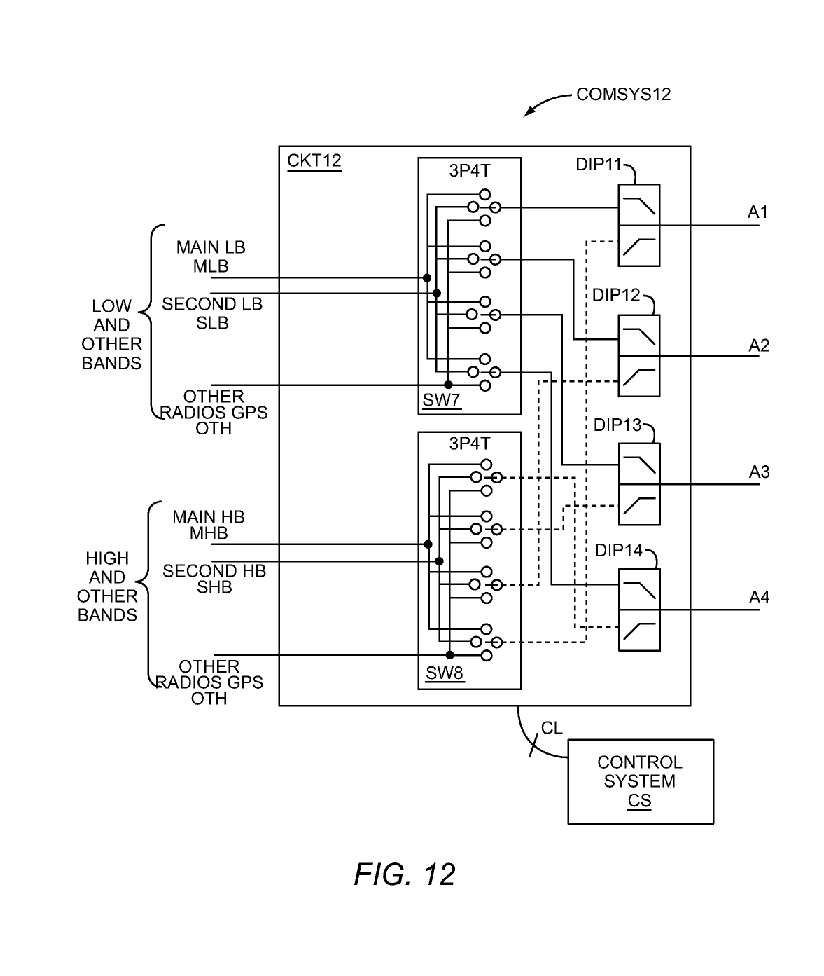

FIG. 12 is an embodiment with diplexers after multiplexers, with four antennas, with a GPS input, and with two 3P4T switches. Specifically, a communication system COMSYS12 comprises communication circuitry CKT12, control system CS, and antennas A1-A4.

FIG. 12 is similar to FIG. 11, except that the third signal OTH is added to both switches in the communication circuitry, instead of just being added to one of these switches.

Specifically, communication circuitry CKT12 includes a first switch SW7, a second switch SW8, and diplexers (DIP11, DIP12, DIP13, and DIP14) associated with antennas (A1, A2, A3, and A4 respectively).

In general, the proposed embodiments can be extended to large numbers of antennas by using multiplexing using mPnT switches. FIG. 12 illustrates using two 3P4T switches for four antennas. This may be extended by using two 3P5T switches for 5 antennas.

Referring back to FIG. 7, FIG. 7 illustrates using two DP4T switches for four antennas. This may be reduced to two DP3T switches for three antennas, or may be increased to two 3P4T switches to accommodate a GPS signal with four antennas. Similarly, FIG. 7 may be increased to two 3P5T for five antennas. Note that DP (“double pole”) is the same as 2P (“two pole”).

TABLE 1
Examples of two mPnT switches (m ≧ 2, n ≧ 3)

| FIRST SWITCH | SECOND SWITCH | FIG. |
|---|---|---|
| 2P3T | 2P3T | FIG. 10 |
| 2P3T | 3P3T | FIG. 11 |
| 3P3T | 3P3T | FIG. 12 |
| 3P4T | 3P4T | Not shown |
| 4P3T | 4P3T | Not shown |
| 2P4T | 2P4T | FIGS. 7 and 9 |
| 2P4T | 3P4T | Not shown |
| 3P4T | 3P4T | Not shown |
| 3P4T | 3P5T | Not shown |
| 3P5T | 3P5T | Not shown |
| 2P5T | 2P5T | Not shown |
| 4P5T | 5P6T | Not shown |

As shown above in Table 1, the multiplexing may be performed by two mPnT switches (m≧2, n≧3). FIG. 10 is the simplest case, with both switches being 2P3T.

The switches do not have to be identical. For example, the first switch may be 2P3T and the second switch may be 3P3T (FIG. 11), or the first switch may be 4P5T and the second switch may be 5P6T (not shown).

Full antenna swapping between the multiplexing switches requires that each switch have a throw connected to each antenna. For example, FIGS. 10 and 11 each have three antennas.

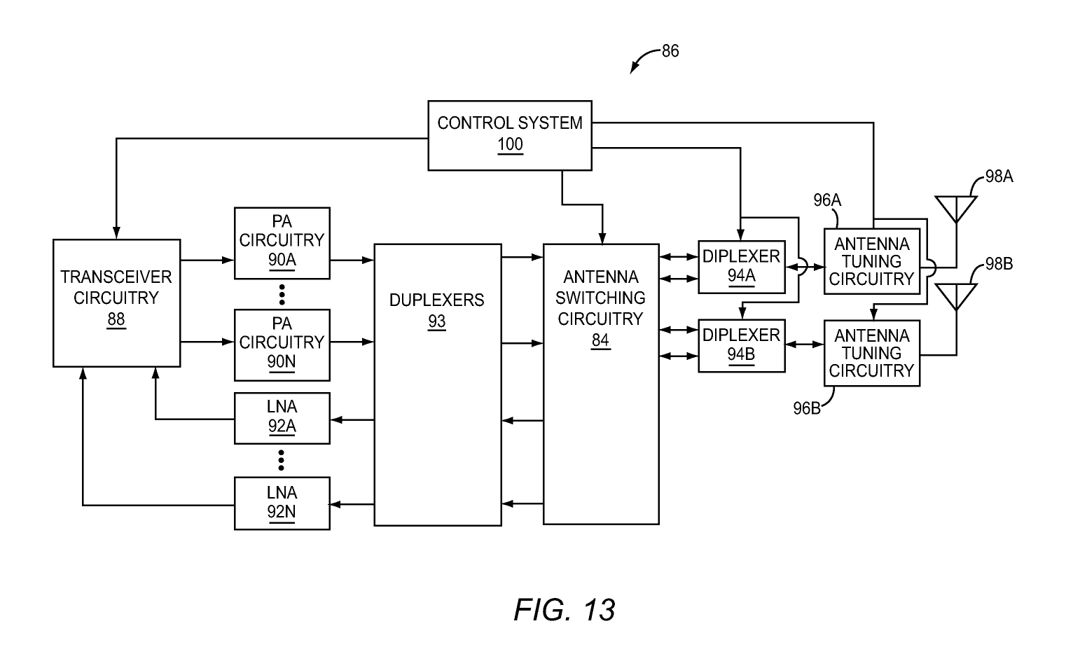

FIG. 13 is a block diagram of front end circuitry. Specifically, FIG. 13 illustrates a first embodiment of antenna switching circuitry 84 incorporated into a mobile terminal front end 86. The basic architecture of the mobile terminal front end 86 includes transceiver circuitry 88, a plurality of power amplifiers 90A-90N, a plurality of low noise amplifiers 92A-92N, duplexer circuitry 93, antenna switching circuitry 84, a first diplexer 94A, a second diplexer 94B, first antenna tuning circuitry 96A, second antenna tuning circuitry 96B, a first antenna 98A, a second antenna 98B, and control system 100. When receiving a signal, the mobile terminal front end 86 receives information bearing radio frequency signals at the first antenna 98A and the second antenna 98B from one or more remote transmitters provided by a base station (not shown). The radio frequency signals pass through the antenna tuning circuitry 96 to the diplexers 94, where the signals are separated into their low band and high band components and delivered to the antenna switching circuitry 84. The antenna switching circuitry 84 selectively couples one or more terminals of the first diplexer 94A, the second diplexer 94B, or both, to one or more of the plurality of low noise amplifiers 92A-92N through the duplexer circuitry 93. One or more of the plurality of low noise amplifiers 92A-92N amplify the received components of the radio frequency signals and deliver them to the transceiver circuitry 88, where they may be subsequently processed and used by the mobile terminal front end 86.

On the transmit side, the transceiver circuitry 88 receives digitized data, which may represent voice, data, or control information. The encoded data is modulated to produce a carrier signal at a desired transmit frequency. The carrier signal is then delivered to one or more of the plurality of power amplifiers 90A-90N, where it is amplified and delivered to the antenna switching circuitry 84 through the duplexer circuitry 93. The antenna switching circuitry 84 selectively couples one or more output terminals of the duplexer circuitry 93 to one or more terminals of the first diplexer 94A, the second diplexer 94B, or both, depending on the mode of operation of the mobile terminal front end 86. The carrier signal is then filtered by the first diplexer 94A, the second diplexer 94B, or both, and delivered through the antenna tuning circuitry 96 to the first antenna 98A, the second antenna 98B, or both, depending on the mode of operation of the mobile terminal front end 86.

By arranging the antenna switching circuitry 84 such that a diplexer exists between each one of the antennas 98 and the antenna switching circuitry 84, harmonics of the carrier signal are filtered by the diplexers, thereby avoiding the desensitization of receive circuitry within the transceiver circuitry 88. For example, the antenna switching circuitry 84 illustrated in FIG. 6 is usable in a carrier aggregation configuration using bands 3 and 8 (CA 3-8, or Carrier Aggregation of band 3 and band 8). When transmitting on band 8, the transceiver circuitry 88 will modulate a carrier signal from 880-915 MHz. The carrier signal will pass through one or more of the plurality of power amplifiers 90A-90N, where it will be amplified and delivered to the antenna switching circuitry 84. The antenna switching circuitry 84 will selectively place the carrier signal into communication with the first diplexer 94A or the second diplexer 94B. Due to non-linearity of the switching components, the antenna switching circuitry 84 will generate harmonic distortion about the carrier signal. As the carrier signal is passed through either the first diplexer 94A, the second diplexer 94B, or both, the harmonic distortion is effectively filtered. Accordingly, the signal at the output of the first diplexer 94A, the second diplexer 94B, or both does not fall within high pass band of each one of the diplexers 94, and therefore is not passed back to the antenna switching circuitry 84. Accordingly, desensitization of the receive circuitry for band 3 is avoided, and the signal passed to the first antenna 98A, the second antenna 98B, or both, is virtually free of harmonic distortion as a result of the antenna switching circuitry 84. A similar result occurs in carrier aggregation configurations using bands 4 and 17 (CA 4-17), in devices simultaneously using band 13 and the GPS band, in devices simultaneously using band 26 and the 2.4 GHz ISM band, and in devices using GSM900 and GSM850 modes, as well as any other combination of operating bands.

According to one embodiment, the first diplexer 94A, the second diplexer 94B, or both may be tunable. By using tunable diplexers for the first diplexer 94A, the second diplexer 94B, or both, harmonic signals about the carrier signal may be further reduced or eliminated. For example, by tuning a stop band in the first diplexer 94A, the second diplexer 94B, or both, to attenuate harmonic signals about the carrier signal, desensitization of the receive circuitry within the transceiver circuitry 88 may be further avoided, as will be discussed in further detail below. Additionally, the first diplexer 94A, the second diplexer 94B, or both, may be tuned to minimize insertion loss in the signal path of the antennas 98, as will be discussed in further detail below.

The control system 100 may be in communication with the antenna switching circuitry 84, the transceiver circuitry 88, the diplexers 94, and the antenna tuning circuitry 96 in order to control one or more operating parameters of the mobile terminal front end 86. For example, the control system 100 may be adapted to place the mobile terminal front end 86 into a diversity mode of operation, wherein the mobile terminal front end 86 is adapted to transmit and receive signals on the first antenna 98A while using the second antenna 98B as a diversity antenna. The control system 100 may also be adapted to place the mobile terminal front end 86 into a multiple input multiple output (MIMO) mode of operation, whereby different signals are transmitted and received by the first antenna 98A and the second antenna 98B simultaneously. The control system 100 may be further adapted to control one or more operating parameters of the first diplexer 94A, the second diplexer 94B, or both. For example, the control system 100 may be adapted to operate the first diplexer 94A, the second diplexer 94B, or both, such that harmonic distortion about the carrier signal is attenuated. Alternatively, the control system 100 may be adapted to operate the first diplexer 94A, the second diplexer 94B, or both, such that insertion loss from the diplexers 94 is reduced.

The antenna tuning circuitry 96 may be configured to ensure optimal operation of the antennas 98 over a wide bandwidth. Although the antenna tuning circuitry 96 may contain one or more switching elements, these switching elements are not adapted to selectively couple the antennas 98 to one of a plurality of RF front end ports within the mobile terminal front end 86.

The duplexer circuitry 93 may be adapted to separate transmit and receive signals such that transmit signals are passed from the power amplifier circuitry 90A-90N to the antenna switching circuitry 84, and receive signals are passed form the antenna switching circuitry 84 to the appropriate low noise amplifier in the plurality of low noise amplifiers 92A-92N. The duplexer circuitry 93 may comprise a plurality of surface acoustic wave (SAW) duplexers, a plurality of bulk acoustic wave (BAW) duplexers, or the like.

According to one embodiment, the antenna switching circuitry 84 is adapted to perform antenna swapping while introducing minimal distortion into a transmit or receive signal. For example, the antenna switching circuitry 84 may be adapted to selectively place one or more of the power amplifiers 90A-90N in communication with either the first antenna 98A or the second antenna 98B based upon an efficiency associated with each antenna. The efficiency may be based, for example, on electrical measurements and/or environmental conditions. Examples of electrical measurements include a reflected transmit power measured by one or more directional couplers, a received signal strength measurement, or a transmit power measured by a base station. Examples of environmental conditions include feedback from one or more sensors to detect the orientation of the mobile device and feedback from sensors that detect how the mobile device is being held.

Antenna switching circuitry 84 may include antenna switch module ASM and diversity switch module DSM of FIG. 9. These switch modules ASM and DSM may receive signals from PA circuitry 90A-90N, or may send signals to LNA 92A-92N.

Those skilled in the art will recognize improvements and modifications to the preferred embodiments of the present disclosure. All such improvements and modifications are considered within the scope of the concepts disclosed herein and the claims that follow.

What is claimed is:

1. A communication system for at least three antennas, the communication system comprising:
a first switch configured to communicate with a main low band signal at a first pole of the first switch and to communicate with a second low band signal at a second pole of the first switch;
a second switch configured to communicate with a main high band signal at a first pole of the second switch and to communicate with a second high band signal at a second pole of the second switch;
a first diplexer configured to communicate with a first antenna;
a second diplexer configured to communicate with a second antenna;
a third diplexer configured to communicate with a third antenna; and
wherein the first switch includes a first throw of the first switch in communication with the first diplexer, a second throw of the first switch in communication with the second diplexer, and a third throw of the first switch in communication with the third diplexer, and
wherein the second switch includes a first throw of the second switch in communication with the first diplexer, a second throw of the second switch in communication with the second diplexer, and a third throw of the second switch in communication with the third diplexer.

2. The communication system of claim 1, further comprising:
a control system configured to control the first switch and the second switch.

3. The communication system of claim 1, wherein the first diplexer is tunable and includes a low pass section and a high pass section.

4. The communication system of claim 3, further comprising:
a control system configured to tune the first diplexer as a function of frequency of operation to minimize insertion losses.

5. The communication system of claim 3, further comprising:
a control system configured to tune a stop band zero in the low pass section of the first diplexer to provide attenuation at a second harmonic of the main low band signal or the second low band signal during transmission.

6. The communication system of claim 3, further comprising:
a control system configured to tune a stop band zero in the low pass section of the first diplexer to provide attenuation at a third harmonic of the main low band signal or the second low band signal during transmission.

7. The communication system of claim 1, wherein the second switch is further configured to communicate with a non-cellular signal at a third pole of the second switch.

8. The communication system of claim 7, further comprising:
a control system configured to control the switches and diplexers to: transmit or receive the main high band signal through the first antenna; receive a diversity signal through the second antenna; and transmit or receive a WiFi signal through the third antenna.

9. The communication system of claim 7, wherein the third diplexer is tunable and includes a low pass section and a high pass section, and the communication system further comprising:
a control system configured to control the switches and diplexers to: transmit or receive the main high band signal through the first antenna; receive a diversity signal through the second antenna; receive a GPS signal through the third antenna; and tune the high pass section of the third diplexer to pass the GPS signal with low losses.

10. The communication system of claim 7, wherein the first switch is further configured to communicate with the non-cellular signal at a third pole of the first switch.

11. A communication system for at least four antennas, the communication system comprising:
a first switch configured to communicate with a main low band signal at a first pole of the first switch and to communicate with a second low band signal at a second pole of the first switch;
a second switch configured to communicate with a main high band signal at a first pole of the second switch and to communicate with a second high band signal at a second pole of the second switch;
a first diplexer configured to communicate with a first antenna;
a second diplexer configured to communicate with a second antenna;
a third diplexer configured to communicate with a third antenna;
a fourth diplexer configured to communicate with a fourth antenna; and
wherein the first switch includes a first throw of the first switch in communication with the first diplexer, a second throw of the first switch in communication with the second diplexer, a third throw of the first switch in communication with the third diplexer, and a fourth throw of the first switch in communication with the fourth diplexer;
wherein the second switch includes a first throw of the second switch in communication with the first diplexer, a second throw of the second switch in communication with the second diplexer, a third throw of the second switch in communication with the third diplexer, and a fourth throw of the second switch in communication with the fourth diplexer.

12. The communication system of claim 11, further comprising:
a control system configured to control the first switch and the second switch.

13. The communication system of claim 11, wherein the first diplexer is tunable and includes a low pass section and a high pass section.

14. The communication system of claim 13, further comprising:
a control system configured to tune the first diplexer as a function of frequency of operation to minimize insertion losses.

15. The communication system of claim 13, further comprising:
a control system configured to tune a stop band zero in the low pass section of the first diplexer to provide attenuation at a second harmonic of the main low band signal or the second low band signal during transmission.

16. The communication system of claim 13, further comprising:
a control system configured to tune a stop band zero in the low pass section of the first diplexer to provide attenuation at a third harmonic of the main low band signal or the second low band signal during transmission.

17. The communication system of claim 11, wherein the second switch is further configured to communicate with a non-cellular signal at a third pole of the second switch.

18. The communication system of claim 17, further comprising:
a control system configured to control the switches and diplexers to: transmit or receive the main high band signal through the first antenna; receive a diversity signal through the second antenna; and transmit or receive a WiFi signal through the third antenna.

19. The communication system of claim 17, wherein the third diplexer is tunable and includes a low pass section and a high pass section, and the communication system further comprising:
a control system configured to control the switches and diplexers to: transmit or receive the main high band signal through the first antenna; receive a diversity signal through the second antenna; receive a GPS signal through the third antenna; and tune the high pass section of the third diplexer to pass the GPS signal with low losses.

20. The communication system of claim 17, wherein the first switch is further configured to communicate with a non-cellular signal at a third pole of the first switch.

21. The communication system of claim 7, wherein the third diplexer is tunable and includes a low pass section having a first bandpass response centered in a low pass band and a high pass section having a second bandpass response centered in a middle/high pass band, and the communication system further comprising:
a control system configured to control the switches and diplexers to: transmit or receive the main high band signal through the first antenna; receive a diversity signal through the second antenna; receive a GPS signal through the third antenna; and tune the high pass section of the third diplexer to pass the GPS signal with low losses.

22. The communication system of claim 21, wherein the third diplexer includes a shunt inductor configured to attenuate very low frequency blockers and configured to tune the low pass section into a band pass.

23. The communication system of 22, wherein the third diplexer further includes a low pass filter in the high pass section configured to attenuate 5 GHz ISM (Industrial Scientific and Medical) band blockers.

24. The communication system of claim 1, wherein the third diplexer is tunable and includes a first tunable bandpass section and a second tunable bandpass section.
